(19) United States
(12) Patent Application Publication
(10) Pub. No.: US 2026/0180483 A1
(43) Pub. Date: Jun. 25, 2026

(54) Electric Drive Unit, Electric Work Device and Method for Pre-Charging an Intermediate Circuit Capacitor of an Electric Drive Unit

(71) Applicant: Andreas Stihl AG & Co. KG, Waiblingen (DE)

(72) Inventor: Christoph WOHLFROM, Heubach (DE)

(21) Appl. No.: 19/426,198

(22) Filed: Dec. 19, 2025

(30) Foreign Application Priority Data
Dec. 20, 2024 (DE) 10 2024 139 257.6

(51) Int. Cl. H02P 27/06; H02K 7/14; H02K 11/00; H02K 11/33

(52) U.S. Cl. CPC H02P 27/06; H02K 7/145; H02K 11/0094; H02K 11/33

(57) ABSTRACT

An electric drive unit includes: an electric motor with at least one stator winding, a DC voltage intermediate circuit with an intermediate circuit capacitor, an inverter with at least one bridge branch for generating at least one control voltage for the at least one stator winding, wherein the at least one bridge branch has at least two semiconductor switches, and a control unit, which is designed to control the at least two semiconductor switches of the at least one bridge branch such that a pre-charging current for pre-charging the intermediate circuit capacitor flows via the at least one stator winding.

### CROSS REFERENCE TO RELATED APPLICATION

This application claims priority under 35 U.S.C. § 119 from German Patent Application No. 10 2024 139 257.6, filed Dec. 20, 2024, the entire disclosure of which is herein expressly incorporated by reference.

### BACKGROUND AND SUMMARY

The object of the invention is to provide an electric drive unit, an electric work device and a method for pre-charging an intermediate circuit capacitor of an electric drive unit that enables pre-charging of the intermediate circuit capacitor in as reliable and cost-effective a manner as possible.

The electric drive unit comprises an electric motor with at least one stator winding.

The electric drive unit further comprises a DC voltage intermediate circuit with an intermediate circuit capacitor. The intermediate circuit capacitor can be formed by a capacitor or by multiple capacitors connected in parallel or in series. The intermediate circuit capacitor can be designed, for example, as an electrolytic capacitor.

The electric drive unit further comprises an inverter with at least one bridge branch for generating at least one control voltage for the at least one stator winding. The at least one bridge branch comprises at least two semiconductor switching devices. The inverter can have, for example, what is known as a B6 topology. The semiconductor switching devices can be, for example, bipolar transistors, MOS transistors or IGBTs.

The electric drive unit further comprises a control unit, for example in the form of a microprocessor controller. The control unit is designed to control the at least two semiconductor switching devices of the at least one bridge branch such that a pre-charging current for pre-charging the intermediate circuit capacitor flows via the at least one stator winding, or rather all stator windings. In other words, the at least one semiconductor switching device and the at least one stator winding each have a dual function. In addition to their conventional function, they are also part of a pre-charging circuit for pre-charging the intermediate circuit capacitor. During pre-charging, the at least one semiconductor switching device and the at least one stator winding can be parts of a DC/DC converter.

In one embodiment, the DC voltage intermediate circuit comprises a positive intermediate circuit branch and a negative intermediate circuit branch. The electric drive unit further comprises: a pre-charging switching device, wherein the intermediate circuit capacitor and the pre-charging switching device are looped in, in this sequence or in the inverted sequence, in series between the positive intermediate circuit branch and the negative intermediate circuit branch. Furthermore, a pre-charging diode is looped in between a connection of the intermediate circuit capacitor, in particular the connection of the intermediate circuit capacitor that is connected to the pre-charging switching device, and a connection of the at least one stator winding. The control unit is designed to control the pre-charging switching device such that the pre-charging switching device is open during pre-charging, i.e., prevents a flow of current, and is closed after pre-charging, i.e., enables a flow of current. The pre-charging switching device can be, for example, a bipolar transistor, an MOS transistor or an IGBT.

In one embodiment, the control unit is designed to control the semiconductor switching devices of the at least one bridge branch such that, alternately, during a first time period, the pre-charging current flows from the positive intermediate circuit branch, via the intermediate circuit capacitor, the pre-charging diode, the at least one stator winding, and via a lower semiconductor switching device of the bridge branch to the negative intermediate circuit branch, and during a second time period, the pre-charging current flows from the positive intermediate circuit branch, via the intermediate circuit capacitor, the pre-charging diode, the at least one stator winding, and via an upper semiconductor switching device of the bridge branch back to the positive intermediate circuit branch.

In one embodiment, the control unit is designed to set the pre-charging current to a predetermined value by suitably setting a ratio of the first time period to the second time period.

In one embodiment, the electric drive unit is designed to be supplied with power from a rechargeable electric energy store, in particular for supplying power to the DC voltage intermediate circuit.

In one embodiment, the electric drive unit comprises exactly three bridge branches. Each bridge branch comprises exactly two semiconductor switching devices.

In one embodiment, the electric motor comprises exactly three stator windings.

The electric work device comprises an electric drive unit as described above. The electric work device further comprises a work tool which is driven by means of the electric motor of the electric drive unit. The work tool can be, for example, a cutting chain, a cutting disk, a blade, etc.

The method according to the invention is used to pre-charge an intermediate circuit capacitor of an electric drive unit as described above. According to the invention, the at least one semiconductor switching device of the at least one bridge branch is controlled such that a pre-charging current for pre-charging the intermediate circuit capacitor flows via the at least one stator winding.

The electric motor can be, for example, a brushless DC motor.

The electric work device can be, for example, a chainsaw, a lawnmower or an angle grinder.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a highly schematic electric work device with an electric drive unit according to an embodiment of the invention;

FIG. 2 is a flowchart with steps during pre-charging of an intermediate circuit capacitor of the work device shown in FIG. 1; and

FIG. 3 is a time characteristic graph of a charging voltage on the intermediate circuit capacitor of the work device shown in FIG. 1.

### DETAILED DESCRIPTION OF THE DRAWINGS

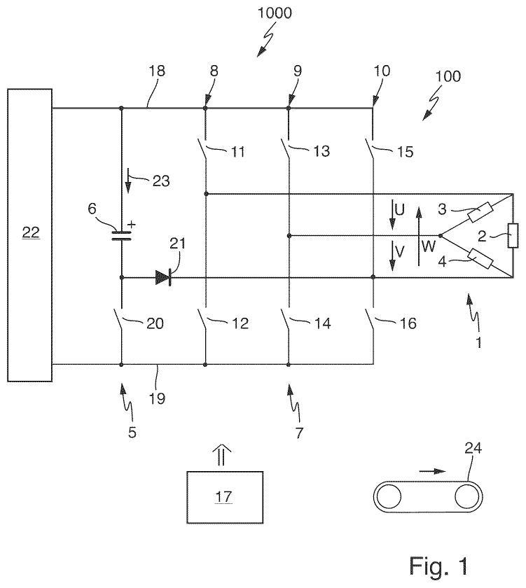

FIG. 1 shows a highly schematic circuit diagram of an electric work device 1000 with an electric drive unit 100 and a work tool 24 symbolized by a circulating chain, which is driven by means of an electric motor 1 of the electric drive unit 100.

The electric drive unit 100 comprises the electric motor 1 with stator windings 2, 3 and 4 in a delta connection.

The electric drive unit 100 further comprises a DC voltage intermediate circuit 5 with an intermediate circuit capacitor 6 in the form of an electrolytic capacitor.

The electric drive unit 100 further comprises an inverter 7 with bridge branches 8, 9 and 10 for generating control voltages u, v and w for the stator windings 2, 3 and 4, wherein each of the bridge branches 8, 9 and 10 comprises two semiconductor switching devices 11 and 12, 13 and 14, and 15 and 16, respectively. The semiconductor switching devices 11 to 16 can each be implemented, for example, as an IGBT with a flyback diode connected in parallel.

The electric drive unit 100 further comprises a control unit 17, which is designed to control the semiconductor switching devices 11 and 12 of the bridge branch 8 such that a pre-charging current 23 for pre-charging the intermediate circuit capacitor 6 flows via the stator winding 2.

The DC voltage intermediate circuit 5 comprises a positive intermediate circuit branch 18 and a negative intermediate circuit branch 19.

The electric drive unit 100 further comprises a pre-charging switching device 20, wherein the intermediate circuit capacitor 6 and the pre-charging switching device 20 are looped in, in this sequence, in series between the positive intermediate circuit branch 18 and the negative intermediate circuit branch 19. The illustrated sequence can also be reversed.

The electric drive unit 100 further comprises a pre-charging diode 21, which is looped in between the connection of the intermediate circuit capacitor 6 that is connected to the pre-charging switching device 20 and a respective connection of the stator winding 2 and the stator winding 4. The anode of the pre-charging diode 21 is connected to the connection of the intermediate circuit capacitor 6 that is connected to the pre-charging switching device 20. The cathode of the pre-charging diode 21 is connected to the respective connection of the stator winding 2 and the stator winding 4.

In contrast to what is illustrated, the positions of the intermediate circuit capacitor 6 and the pre-charging switching device 20 can also be reversed, i.e., the intermediate circuit capacitor 6 is connected to the negative intermediate circuit branch 19 and the pre-charging switching device 20 is connected to the positive intermediate circuit branch 18. In this case, the pre-charging diode 21 would need to be installed in the opposite direction.

The control unit 17 controls the pre-charging switching device 20 such that the pre-charging switching device 20 is open during pre-charging and closed after pre-charging.

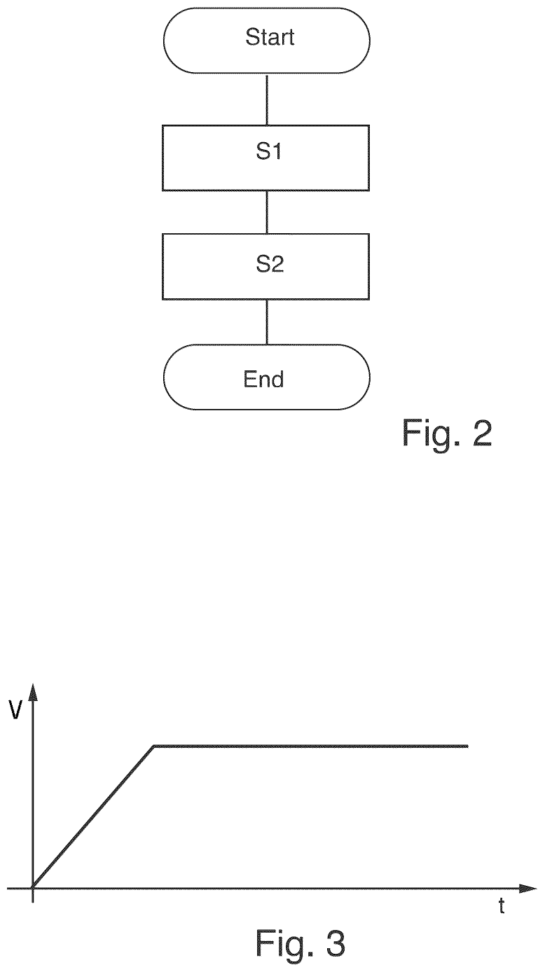

The control unit 17 controls the semiconductor switching devices 11 and 12 such that, alternately, during a first time period, the pre-charging current 23 flows from the positive intermediate circuit branch 18, via the intermediate circuit capacitor 6, the pre-charging diode 21, the stator winding 2 and the stator windings 3 and 4, and via the lower semiconductor switching device 12 of the bridge branch 8 to the negative intermediate circuit branch 19, see step S1 in FIG. 2. And, alternatively, during a second time period, the pre-charging current 23 flows from the positive intermediate circuit branch 18, via the intermediate circuit capacitor 6, the pre-charging diode 21, the stator winding 2 and the stator windings 3 and 4, and via the upper semiconductor switching device 11 of the bridge branch 8 back to the positive intermediate circuit branch 18, see step S2 in FIG. 2. The control unit 17 adjusts the pre-charging current 23 to a predetermined value by suitably setting a ratio of the first time period to the second time period.

The DC voltage intermediate circuit 5 is supplied with power from a rechargeable electric energy store 22.

Electrolytic capacitors must be charged before use, for example after switching on the device. Charging is usually performed using additional charging resistors and charging switches, in which at least the energy content of the capacitor is additionally converted into heat during charging. The capacitor is typically charged here using an e-function. After charging, such a charging circuit is bridged for operation using a further switching device. Alternatively, the switching device is also over-dimensioned such that it can withstand the enormous current peak of unlimited charging.

After being charged, the intermediate circuit capacitor 6 is connected via the pre-charging switching device 20. The intermediate circuit capacitor 6 is first charged via the inverter 7 and the motor windings 2, 3 and 4. By slowly incrementing one motor phase, the pre-charging current 23 is provided in the intermediate circuit capacitor 6. As a result, the pre-charging switching device 20 can switch on nearly without current.

This enables fast pre-charging with a nearly constant amperage. Furthermore, only one additional diode 21 is required. Low levels of losses occur due to the charging inductance. One connection of the pre-charging switching device 20 can be connected to the negative intermediate circuit potential.

An exemplary time characteristic of a charging voltage on the intermediate circuit capacitor 6 is illustrated in FIG. 3.

According to the invention, the motor windings 2, 3 and 4 of the electric motor 1 connected to the output side of the inverter 7 are used to pre-charge the intermediate circuit capacitor 6, leading to a dual benefit and allowing additional components to be dispensed with.

By means of the single pre-charging diode 21 between the intermediate circuit capacitor 6 and one motor phase in combination with skillful control of another motor phase, the intermediate circuit capacitor 6 can be charged to slightly over 100% with a nearly constant charging current. Due to the motor inductance, low levels of losses, or else losses at locations that are in principle designed for these losses, occur in this case. As a result, the components used can be reduced, possibly saving costs and space.

During pre-charging, the semiconductor switches 11 and 12 switch alternately.

While the semiconductor switching device 12 is closed and the semiconductor switching device 11 is open, the pre-charging current 23 builds up via the stator windings 2, 3 and 4, the pre-charging diode 21 and the intermediate circuit capacitor 6, thus charging the intermediate circuit capacitor 6.

When a desired pre-charging amperage is reached, the semiconductor switching device 12 is opened and the semiconductor switching device 11 is closed, wherein the pre-charging current 23 is reduced again while simultaneously charging the intermediate circuit capacitor 6.

The pre-charging current can be set by adapting the switching times of the semiconductor switching device 11 and 12.

The inner and limiting diode in the semiconductor switch 16 and the diode voltage of the pre-charging diode 21 can be used to evenly pre-charge the intermediate circuit capacitor 6 to over 100% of its operating voltage.

The pre-charging, which according to the invention protects the system while also being fast, enables frequent pre-charging processes and reduces damage to the electrolytic capacitor due to the limitation of the switch-on current.

Charging via the stator winding(s), or rather motor inductance(s), 2, 3, and/or 4 has considerably fewer charging losses compared to resistive charging limitation.

Due to the invention's limitation of the pre-charging current by means of circuitry, there is no dependency with regard to internal resistances of the source, or rather of the rechargeable electric energy store, or rather battery 22.

The intermediate circuit capacitor, or rather electrolytic capacitor, 6 is charged with constant amperage, as a result of which the charging period is shortened compared to a method in which the pre-charging current decreases exponentially over time due to the opposing field that develops as the duration increases.

Conventional pre-charging resistors can be dispensed with.

A pre-charging switching device 20 that may be present can be connected to ground, as a result of which cheaper parts can be used and a power supply for a pre-charging switching device connected in a different manner can be dispensed with.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An electric drive unit, comprising:
an electric motor with at least one stator winding;
a DC voltage intermediate circuit with an intermediate circuit capacitor;
an inverter with at least one bridge branch for generating at least one control voltage for the at least one stator winding, wherein the at least one bridge branch comprises at least two semiconductor switches; and
a control unit which is designed to control the at least two semiconductor switches of the at least one bridge branch such that a pre-charging current for pre-charging the intermediate circuit capacitor flows via the at least one stator winding.

2. The electric drive unit according to claim 1, wherein
the DC voltage intermediate circuit comprises a positive intermediate circuit branch and a negative intermediate circuit branch, and
the electric drive unit further comprises:
a pre-charging switch, wherein the intermediate circuit capacitor and the pre-charging switch are looped in, in series, between the positive intermediate circuit branch and the negative intermediate circuit branch, and
a pre-charging diode which is looped in between a connection of the intermediate circuit capacitor and a connection of the at least one stator winding,
wherein the control unit is designed to control the pre-charging switching device such that the pre-charging switching device is open during pre-charging and closed after pre-charging.

3. The electric drive unit according to claim 2, wherein
the pre-charging diode is looped in between the connection of the intermediate circuit capacitor that is connected to the pre-charging switching device and the connection of the at least one stator winding,

4. The electric drive unit according to claim 2, wherein
the control unit is designed to control the at least two semiconductor switches of the at least one bridge branch such that, alternately,
during a first time period, the pre-charging current flows from the positive intermediate circuit branch, via the intermediate circuit capacitor, the pre-charging diode, the at least one stator winding, and via a lower semiconductor switch of the bridge branch to the negative intermediate circuit branch, and
during a second time period, the pre-charging current flows from the positive intermediate circuit branch, via the intermediate circuit capacitor, the pre-charging diode, the at least one stator winding, and via an upper semiconductor switch of the bridge branch back to the positive intermediate circuit branch.

5. The electric drive unit according to claim 4, wherein
the control unit is designed to set the pre-charging current to a predetermined value by suitably setting a ratio of the first time period to the second time period.

6. The electric drive unit according to claim 1, wherein
the electric drive unit is designed to be supplied with power from a rechargeable electric energy store for supplying power to the DC voltage intermediate circuit.

7. The electric drive unit according to claim 1, wherein
the electric drive unit comprises exactly three bridge branches and each bridge branch comprises exactly two semiconductor switches.

8. The electric drive unit according to claim 1, wherein
the electric motor comprises exactly three stator windings.

9. An electric work device, comprising:
an electric drive unit according to claim 1; and
a work tool which is driven via the electric motor of the electric drive unit.

10. A method for pre-charging an intermediate circuit capacitor of an electric drive unit, wherein the electric drive unit comprises:
an electric motor with at least one stator winding;
a DC voltage intermediate circuit with an intermediate circuit capacitor; and
an inverter with at least one bridge branch for generating at least one control voltage for the at least one stator winding, wherein the at least one bridge branch comprises at least two semiconductor switches,
wherein the method comprises the steps of:
controlling the at least two semiconductor switches of the at least one bridge branch such that a pre-charging current for pre-charging the intermediate circuit capacitor flows via the at least one stator winding.
